(19) United States
(12) Patent Application Publication
(10) Pub. No.: US 2026/0231956 A1
(43) Pub. Date: Aug. 13, 2026

(54) DOUGH SHEETING MACHINE WITH INTEGRATED RETAINING BAND ASSEMBLY AND METHOD OF USE

(71) Applicant: GENERAL MILLS, INC., Minneapolis, MN (US)

(72) Inventors: Robbie Roy Crowley, Lewistown, MO (US); Adam Renaud Dillard, Hannibal, MO (US); Bryan Lee Luckey, Hannibal, MO (US); Daniel Murray, Roscoe, IL (US); Richard Tumbleson, Hannibal, MO (US)

(73) Assignee: GENERAL MILLS, INC., Minneapolis, MN (US)

(21) Appl. No.: 19/473,240

(22) PCT Filed: Mar. 28, 2024
(86) PCT No.: PCT/US2024/021874

§ 371 Date: Oct. 7, 2025

Related U.S. Application Data
(60) Provisional application No. 63/457,987, filed on Apr. 7, 2023.

(51) Int. Cl. A21C 3/02; B08B 1/16

(52) U.S. Cl. CPC A21C 3/02; B08B 1/165

(57) ABSTRACT

A dough sheeting machine (10) includes an alignment bracket (62) employed in combination with a welding unit (200) to form retaining bands (74) used to retain a traveling wire (76) of the dough sheeting machine (10) in an operational position. The alignment bracket (62) includes a central recess (64) for supporting the welding unit (200) and an alignment channel (68) for supporting the retaining band (74). The welding unit (200) is configured to place the band (74) in tension, and then to friction weld first and second ends (234, 236) of the band (74) together to form a retaining hoop around a roller (40) and the wire (76). The retaining hoop is slid into a respective circumferential groove (73) provided about the roller(40) of the dough sheeting machine (10). Clamps (69) are located on the alignment bracket (62) for securing the retaining band (74) during welding.

### FIELD OF THE INVENTION

The invention generally pertains to a dough sheeting machine, such as for use in making hard taco shells. More particularly, the invention pertains to a sheeting machine with a traveling wire assembly including a retaining band for securing the traveling wire in an operational position along a roller of the sheeting machine and to an assembly for welding the retaining band in-situ around the roller of the sheeting machine.

### BACKGROUND OF THE INVENTION

A dough sheeting machine or sheeter is a device commonly used in the food industry for making flattened food products in a continuous processing operation. Dough sheeting machines are used in the production of thin corn products formed from unleavened cornmeal dough such as tortillas and tacos. These machines typically have a pair of counter rotating sheeting rollers positioned beneath a hopper. The dough product drops from the hopper and is compressed between the sheeting rollers that are located closely together, thereby providing a pinch point through which the dough is formed into sheets. The sheets are then cut into shaped products before dropping onto a conveyor that brings the shaped product to an oven. Many dough products, particularly those that are corn based (“masa”), tend to stick to the sheeter rollers rather than dropping onto the conveyer.

One common approach to this problem is to string a traveling wire across the face of one of the sheeter rollers so that the traveling wire can scrape away the dough product off of the surface of the roller. A cutting device acting against the roller outlines product pieces in the sheet. A traveling wire is provided to strip the masa sheet and the product pieces from the roller after the cutting operation.

The roller is provided with spaced circumferential grooves in which retaining hoops are loosely positioned. The retaining hoops are often formed from retaining bands having adjustably interlocking ends. The formed retaining hoops have a diameter slightly less than that of the roller so that they remain captive within the grooves. The grooves are sufficiently deep to allow the hoops to assume eccentric positions in which at least portions of the hoops protrude from the grooves a significant distance.

As the masa sheet is formed between the sheeting rollers, the masa is pressed against the retaining hoops, as well as the cylindrical surfaces of the rollers. With this arrangement, the masa sheet also adheres to the retaining hoops. The traveling wire is threaded through the retaining hoops so that, as the wire peels the masa sheet from the surface of the roller, the sheet continues to adhere to the retaining hoops and the cut pieces are severed from the sheet and fall onto the conveyor as the sheet is peeled from the sheeter roller, but the remainder of the sheet is carried back into the hopper. Typically, piano wire or similar high tensile strength round wire has been used exclusively as the traveling wires. The traveling wire is often arranged to shift along the roller so that the section of wire peeling the dough is constantly refreshed. A guide wire may also be employed to assist with guiding the traveling wire.

Employing retaining bands with interlocking ends can result in the retaining hoops breaking or failing while on the sheeter rollers, leading to excess waste and downtime for repairs. In addition, while hoops that are preformed may be stronger that those with interlocking ends, preformed hoops are difficult to install. In particular, preformed hoops require removal of the rollers, which are heavy and difficult to move. Therefore, there exists a need for a device that will provide a stronger way to connect the ends of the retaining bands and thus create a stronger bond and also allow for installing the bands in situ, without removing the rollers.

### SUMMARY OF THE INVENTION

A dough sheeting machine is provided with housing that includes an alignment device for aligning first and second ends of a plastic wire retaining band. The alignment bracket may be integrally formed with the housing or be formed as a separate bracket attached to the housing. Preferably, the bracket includes a central recess for supporting a friction welding unit and an alignment channel for supporting the first and second ends of the retaining band in alignment during welding. The dough sheeting machine includes a support housing and a sheeter roller supported in the housing. The sheeter roller has a cylindrical surface with a channel extending circumferentially around the cylindrical surface. The plastic, wire retaining band, once welded, is in the form of a retaining hoop and is placed around the roller in the channel. The alignment bracket is mounted in the support housing.

The friction welding unit is removably mounted on the alignment bracket and is at least partially located in the central recess. The welding unit, in combination with the alignment bracket, is configured to consistently align the first end of the plastic band over the second end of the band, tighten the band, and then friction weld the first and second ends of the band together. Clamps are located on the alignment bracket for securing the retaining band during welding. The first and second ends of the retaining band are thus joined with a consistent weld to establish the retaining hoop.

In accordance with the invention, the retaining hoop is formed while being installed on the sheeting roller of the dough sheeting machine. More specifically, the first and second ends of the retaining band are pulled around the sheeting roller and over a traveling wire so that the ends meet at the retaining bracket. The first and second ends of the retaining band are placed in an alignment channel located in the alignment bracket. The retaining band is adjusted by stretching the band across the alignment bracket so that the retaining band is under tension. The ends of the retaining band are then held in place with the clamps. The welding unit is then positioned in the alignment bracket. Positioning the welding unit in the support bracket preferably includes placing the welding unit at least partially in a central recess of the support bracket to align the welding unit relative to the retaining band. The welding unit is placed around the first and second aligned ends of the retaining band. The welding unit is then activated to tighten and then weld the aligned first and second ends together to form a retaining hoop with a consistent aligned weld. Preferably, the welder is a friction welder, and the retaining band is formed of plastic. Also, welding the aligned first and second ends of retaining band to form a retaining hoop with the consistent aligned weld is preferably conducted with friction welding. The retaining hoop is stretched and moved onto the roller to retain a traveling wire in proper position. Preferably, the retaining hoop is placed in the channel extending circumferentially around a cylindrical surface of the roller.

### BRIEF DESCRIPTION OF THE DRAWINGS

FIG. 1 is a perspective view of a dough sheeting machine with a hopper.

FIG. 2 is an upper perspective view of the dough sheeting machine of FIG. 1 with the hopper removed, showing sheeter rollers and an alignment bracket.

FIG. 3 is a lower perspective view of the underside of the dough sheeting machine of FIG. 1 showing one of the sheeter rollers and a cutting roller with retaining bands supporting a traveling wire on the sheeter roller.

FIG. 4 is a lower front perspective view of a welder.

FIG. 5 is a top view of the welder of FIG. 4 placed in the alignment bracket of FIG. 2.

FIG. 6 shows cutting a retaining hoop after welding.

FIG. 7 shows a close-up view of the alignment bracket of FIG. 2.

FIG. 8 shows an alternative embodiment of the alignment bracket.

Additional objects, features and advantages of the invention will become more readily apparent from the following detailed description of preferred embodiments thereof when taken in conjunction with the drawings wherein like reference numerals refer to common parts in the several views.

### DETAILED DESCRIPTION OF EMBODIMENTS

The following detailed description should be read with reference to the drawings in which similar elements in different drawings are numbered the same. The detailed description and the drawings, which are not necessarily to scale, set forth illustrative and exemplary embodiments and are not intended to limit the scope of the disclosure.

Selected features of any illustrative embodiment can be incorporated into an additional embodiment unless clearly stated to the contrary. While the disclosure is amenable to various modifications and alternative forms, specifics thereof have been shown by way of example in the drawings and will be described in detail. As used herein in the specification and claims, including as used in the examples and unless otherwise expressly specified, all numbers may be read as if prefaced by the word “about” or “approximately,” even if the term does not expressly appear, with it being understood that this provides a reasonable expected range of values in the order of +/−10% of the stated value (or range of values). In addition, any numerical range recited herein is intended to include all sub-ranges subsumed therein. Overall, it should be understood, however, that the intention is not to limit aspects of the disclosure to the particular illustrative embodiments described. On the contrary, the intention is to cover all modifications, equivalents, and alternatives falling within the spirit and scope of the disclosure.

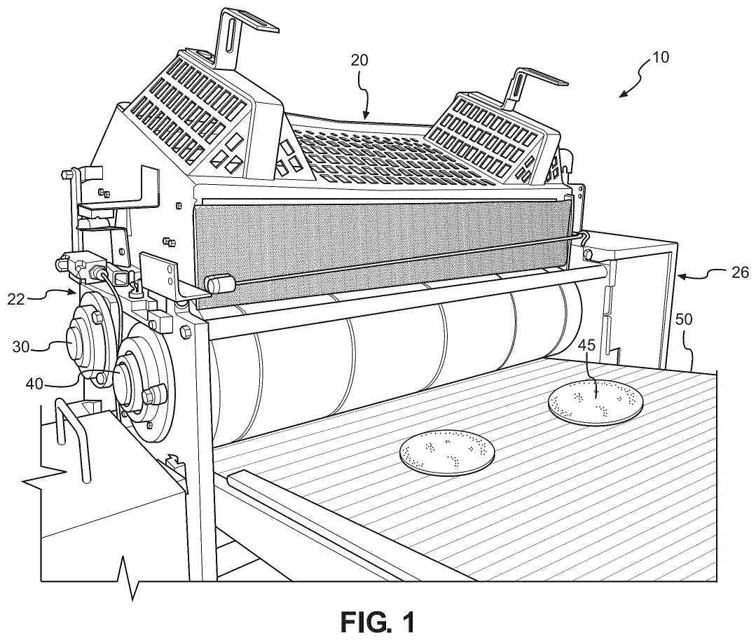

FIG. 1 illustrates a dough sheeting machine 10. The dough sheeting machine 10 is configured for taco production, and can include various types of electronic thickness control, pinch point gap control, and other related systems and functionality. Regardless of this illustrated embodiment, the invention disclosed herein has applicability to a variety of different types of food rolling machines and sheeters. However, dough sheeting machine 10, configured to make tacos, provides useful context for appreciation of the embodiments disclosed herein.

With continued reference to FIG. 1, the dough sheeting machine 10 includes a hopper assembly 20, roller assembly 22 and a support housing 26. The support housing 26 is in the form of a support frame assembly which can include and support various types of devices for operations of dough sheeting machine 10. The roller assembly 22 includes two rollers, a rear roller 30 and a front roller 40, both of which are generally cylindrical. The rear roller 30 and the front roller 40 are rotated in opposite directions and can be driven at the same speed or slightly different speeds, depending on desired performance characteristics. The rear roller 30 and the front roller 40 are positioned generally parallel to each other. The roller assembly 22 can include an electric motor and an appropriate gear reduction mechanism (not separately shown) for driving a shaft of one or both of rear roller 30 and front roller 40. Further details of an electric motor and drive system can be found in US 2021/0298314, incorporated herein by reference. The roller assembly 22 is rotatably carried by support housing 26. The hopper assembly 20 is supported above the roller assembly 22. In this embodiment, the hopper assembly 20 supplies dough to the rear roller 30 and the front roller 40, with the dough being sheeted and cut so that the dough sheeting machine 10 produces round shaped dough pieces 45 on a conveyor 50.

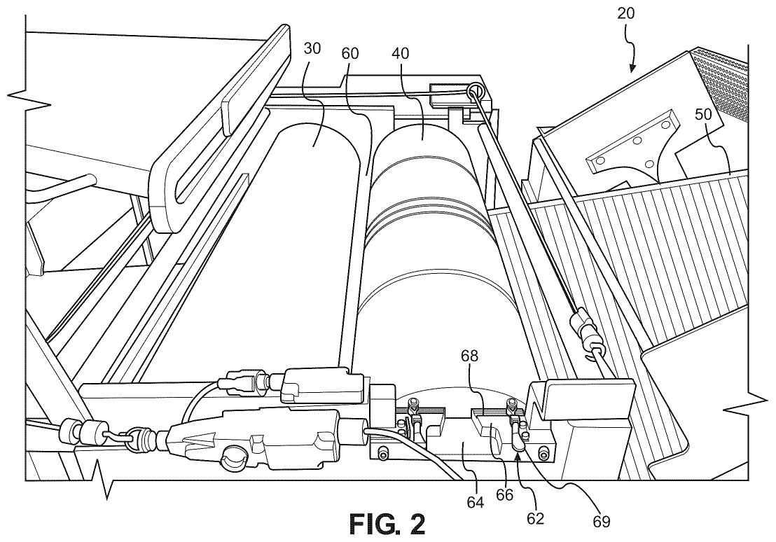

More specifically and with reference to FIG. 2, the hopper assembly 20 has been moved to show how the rear roller 30 and the front roller 40 are mounted parallel to each other to define a pinch point gap 60. The hopper assembly 20 is normally mounted above the rear roller 30 and the front roller 40 (FIG. 1) so as to support dough (not separately shown), such as masa above the pinch point gap 60. As the rear roller 30 and the front roller 40 are driven in counter-rotating directions, the masa is pulled into the pinch point gap 60. A thin layer or sheet of dough is discharged from the pinch point gap and adheres to an outer surface of the front roller 40.

Also shown in FIG. 2 is an alignment bracket 62, which is mounted in the support housing 26. The alignment bracket 62 has a central recess 64. The central recess 64 is formed generally in a T-shape, with the bottom of the T facing roller 40. The central recess 64 has a generally flat bottom wall and upwardly extending side walls (not separately labeled). An upper surface 66 of the alignment bracket 62 extends on each side of the central recess 64. A channel 68 is formed in the upper surface 66 of alignment bracket 62 and extends on both sides of the central recess. A pair of clamps 69 is also located on the upper surface 66, with one clamp being one side of the central recess 64 and the other clamp being positioned opposite the first clamp and on the other side of the central recess.

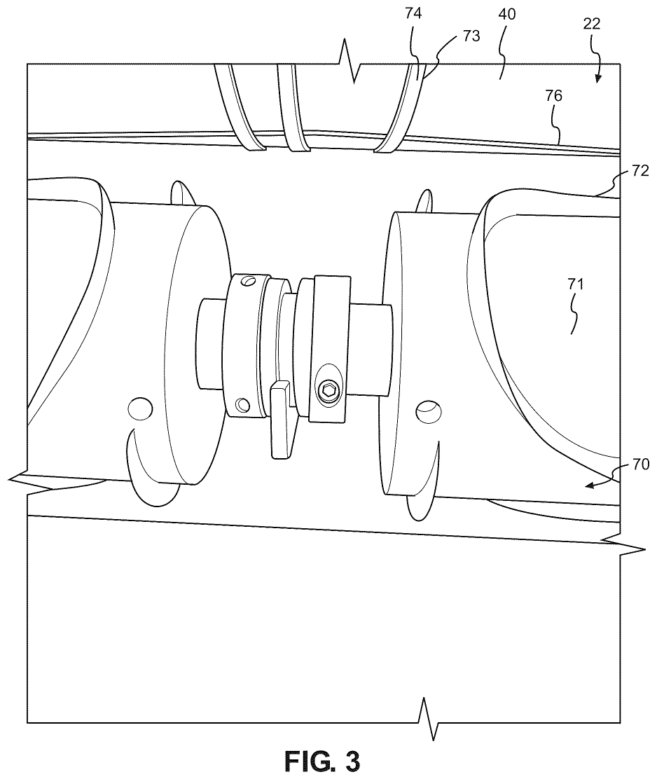

With reference to FIG. 3, the roller assembly 22 can also include a cutting roller 70. As the sheet of dough moves counterclockwise along with the front roller 40, the dough is passed between the cutting roller 70 and the outer surface of the front roller 40. The cutting roller 70 is designed for taco manufacturing, and thus includes round-shaped recesses 71 and edges 72 for cutting the round shaped dough pieces 45. While round shapes are shown, the cutting roller 70 could cut the dough sheet into any desired shape. The front roller 40 also includes various longitudinally spaced grooves 73 extending circumferentially around the cylindrical surface of the front roller 40, and a respective retaining band 74 is disposed in each groove 73. Preferably a series of spaced longitudinal groove and band combinations are employed, with each groove 73 including an inner surface having a smaller diameter than the inner surface of the retaining band 74. That is, the retaining band 74 is sufficiently, diametrically large such that the retaining band 74 can slightly project from the outer surface of front roller 40.

A stripper or traveling wire 76 is secured to roller assembly 22 at locations adjacent both ends of front roller 40 and downstream from cutting roller 70. More specifically, traveling wire 76 is mounted at one end of front roller 40 adjacent to a right-most point of contact and secured at an opposing end of front roller 40 adjacent to a left-most point of contact. The traveling wire 76 is shown strung across the face of front roller 40. More specifically, traveling wire 76 is threaded across the face of the front roller 40 underneath each retaining band 74 in order to provide a flush contact between the traveling wire 76 and the surface of front roller 40. Traveling wire 76 may be held under tension and also moved along the surface of the front roller 40. Details of a device for providing tension to the traveling wire can be found in U.S. Pat. No. 6,268,005, incorporated herein by reference.

With continued reference to FIG. 3, during operation, the rotation of front roller 40, and the resulting friction between traveling wire 76 and the outer surface of front roller 40 and retaining band 74 causes traveling wire 76 to be pulled in the upward direction. As such, traveling wire 76 tends to follow an arched shape around front roller 40. Each retaining band 74 rides in a respective one of grooves 73 in front roller 40 and holds traveling wire 76 close to the surface of front roller 40. With this arrangement, during operation of dough sheeting machine 10, traveling wire 76 strips off cut pieces of dough from the outer surface of front roller 40, yet allows remaining pieces of dough, referred to as “rework”, to remain in contact with retaining band 74 and be fed back into hopper assembly 20 so as to become reworked with the dough above pinch point gap 60.

The traveling wire 76 is typically commercial piano wire. A typical tension on traveling wire 76 during operation is approximately 100 to 125 pounds. Contact with hardened masa, particularly during start-up, can subject traveling wire 76 to even higher tension values for short time periods. During operation, traveling wire 76 is also subject to friction from the moving face of front roller 40.

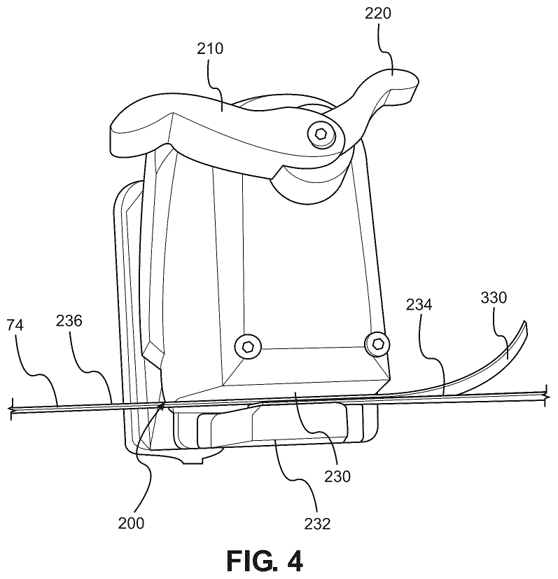

Turning to FIG. 4 there is shown a welding unit 200 employed in connection with this embodiment of the invention. Welding unit 200 is preferably a friction welder, but could take other forms, such as a sonic welder. Welding unit 200 is provided with a friction weld sealing lever 210 with two arms, one of which is labeled 220. Welding unit 200 also includes a housing 230 attached to a base 232 that is configured to fit securely within central recess 64 of alignment bracket 62 (FIG. 2). Specifically, the shape of base 232 is complementary to the shape of central recess 64. That is to say, base 232 of welding unit 200 fits into the central recess at a specified location which is a set distance from channel 68. There is no need for the shape of base 232 to exactly conform to the shape of central recess 64, although such an arrangement is preferable. Also, there is a slight spacing between base 232 and housing 230 to allow for placement of retaining band 74. The bottom of housing 230 and the top of base 232 act as jaws, holding first end 234 and second end 236 of retaining band 74 therebetween in an overlapping arrangement during welding.

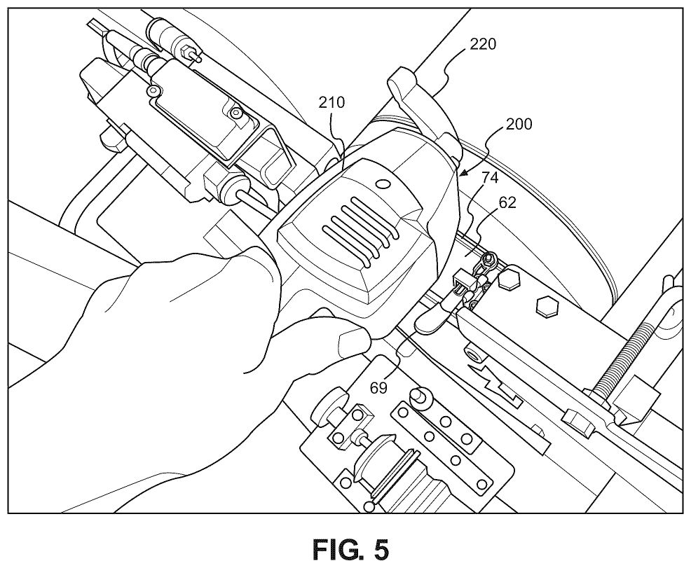

FIG. 5 shows welding unit 200 placed at least partially in central recess 64. Retaining band 74 is shown in channel 68 retained in place by clamps 69. The welding unit is placed so that the ends of retaining band 74 are within the jaws of welding unit 200. Retaining band 74 is preferably formed from a thermoplastic strap, such as those commonly used in the packing industry. Conventional thermoplastic straps have a thickness of between about 0.254 mm and about 0.889 mm. The welding unit 200 is also preferably a friction welder that could also be used in the packing industry. For example, such welders are commercially available under the model named ZAPAC. Such welding units work by placing overlapping strap end portions within the welder jaws. The welding unit 200 will first apply tension to the end portions of retaining band 74 and then apply friction to melt the two ends together. Details of how such welding units work can be found in U.S. Pat. Nos. 5,133,532 and 6,332,306, both of which are incorporated herein by reference.

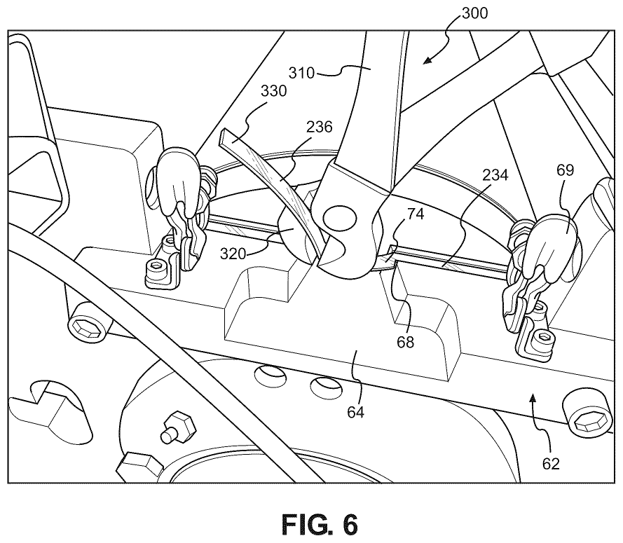

FIG. 6 shows retaining band 74 in alignment bracket 62 after welding unit 200 has been removed. The retaining band 74 is still located in channel 68 but is now in the form of a retaining hoop having an excess portion 330. A cutting tool 300, having a handle 310 and opposing blades 320, is used to remove excess portion 330.

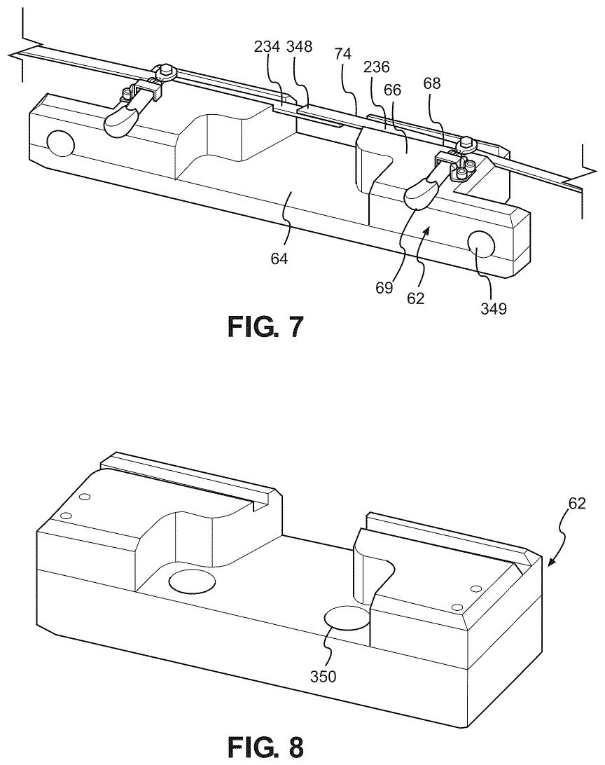

FIG. 7 shows alignment bracket 62 removed from support housing 26 for clarity. The retaining band 74 is shown with first end 234 being welded to second end 236 to form a consistently strong friction weld 348. The ends are typically bonded together with the friction weld 348 to a thickness of between about 0.013 mm and 0.051 mm in each overlapping strap portion across the entire width of the strap. Typically, the length of the friction weld 348 extends for about 10 mm to about 35 mm along the length of the overlapping strap portions. The alignment bracket 62 can be attached to support housing 26 with two fasteners that pass through holes 349 provided in a front face of alignment bracket 62. FIG. 8 show an alternative preferred embodiment of the invention with an alternative placement of pass-through holes 349.

In using welding unit 200, hopper assembly 20 is moved off of support housing 26 to gain access to rollers 30 and 40, as best seen in FIG. 2. A retaining band 74 is then placed under roller 40 and the first end of the retaining band 74 is placed in channel 68 on one side of alignment bracket 62 and the second end of the retaining band 74 is placed in channel 68 on the other side of the alignment bracket 62. The traveling wire 76 is preferably located between the retaining band 74 and the roller 40 as seen in FIG. 3. The ends of the retaining band 74 are arranged to overlap in central recess 64 of alignment bracket 62. One end of the retaining band 74 includes the excess portion 330 that will be cut off. The retaining band 74 is pulled tight, thus stretching the retaining band 74 across the alignment bracket 62 so that retaining band 74 is placed under tension before being held in place with clamps 69. As such, first end 234 and second end 236 of retaining band 74 are aligned with each other.

Next welding unit 200 is placed in alignment bracket 62 and pushed into central recess 64 until base 232 of welding unit 200 hits the upright walls of alignment bracket 62. Retaining band 74 is located within the jaws of the welding unit 200 as shown in FIGS. 4 and 5. The alignment bracket 62 ensures that the ends of the retaining band 74 when placed in channel 68 are aligned with each other and correctly located with respect to welding unit 200. Next, welding unit 200 is activated, preferably by squeezing a trigger to clamp welding unit 200 to the retaining band 74. A friction weld sealing lever 210 is rotated counterclockwise to initiate welding. The welding unit 200 will further tighten retaining band 74 and then weld together first end 234 and second end 236 of retaining band 74 to form a retaining hoop. The resulting aligned weld 351 will be much stronger that welds formed with the ends of a retaining band which are not aligned. The trigger is then released, and friction weld sealing lever 210 is rotated clockwise to release retaining band 74. The welding unit 200 is then removed from alignment bracket 62, as shown in FIG. 6. The clamps 69 are released, and the excess portion 330 is trimmed from the retaining band 74. Retaining band 74 is then removed from. channel 68 and slid over roller 40 until placed in a respective groove 73, such as shown in FIG. 3.

As should be evident from the above discussion, the preferred embodiments disclose a device for providing a consistent weld to connect the ends of the retaining band and thus create a stronger bond. Although various illustrative embodiments are described above, changes may be made to the various disclosed embodiments without departing from the scope of the invention as encompassed by the claims. For example, the alignment bracket could be integrally formed with the support housing or the order in which various described method steps are performed may be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

1. A dough sheeting machine comprising:
a roller including a cylindrical outer surface formed with a groove extending circumferentially around the cylindrical outer surface;
a wire extending across the cylindrical outer surface of the roller for removing dough from the roller during operation of the dough sheeting machine; and
a housing for supporting the roller and the wire, said housing including an alignment bracket configured to hold first and second ends of a retaining band, the alignment bracket also being configured to hold a welding unit in alignment with the first and second ends of the retaining band during welding so that the first and second ends are welded to form a retaining hoop positioned around the roller and the wire, the retaining hoop being configured to be received in the groove of the roller to retain the wire against the cylindrical outer surface.

2. The dough sheeting machine of claim 1, further comprising a retaining hoop located in the groove and wherein the wire is retained against the cylindrical outer surface with the retaining hoop.

3. The dough sheeting machine of claim 1, wherein the alignment bracket is integrally formed with the housing.

4. The dough sheeting machine of claim 1, wherein the alignment bracket is attached to the housing.

5. The dough sheeting machine of claim 1, further comprising, in combination, a welding unit, wherein the alignment bracket is formed with central recess having a shape that conforms to part of the welding unit such that the welding unit mates with the central recess and is aligned with respect to a channel formed in the alignment bracket for holding the first and second ends of the retaining band during welding.

6. The dough sheeting machine of claim 1, further comprising clamps located on the alignment bracket.

7. The dough sheeting machine of claim 1, further comprising a welding unit, wherein the welding unit is a friction welder.

8. The dough sheeting machine of claim 7, wherein the retaining band is formed of flexible plastic.

9. The dough sheeting machine of claim 8, wherein the retaining band includes a weld joining the first end and second ends of the retaining band formed by the welding unit.

10. A method of installing a retaining hoop on a roller mounted in a support housing of a dough sheeting machine having a wire for scraping the roller, said method comprising:
positioning a welding unit in a recess of an alignment bracket of the support housing;
maintaining a first end and a second end of a retaining band in overlapping alignment with each other in a channel formed in the alignment bracket;
adjusting a length of the retaining band;
welding the first end and the second end of the retaining band to form a retaining hoop positioned around the wire; and
moving the retaining hoop into a groove extending circumferentially around a cylindrical outer surface of the roller.

11. The method of claim 10, further comprising positioning the retaining hoop in the groove and retaining the wire in proper position with the retaining hoop.

12. The method of claim 10, wherein positioning the welding unit in the alignment bracket includes placing the welding unit at least partially in the recess of the alignment bracket to align the welding unit relative to the first end and the second end of the retaining band.

13. The method of claim 10, wherein adjusting the length of the retaining band includes stretching the retaining band across the alignment bracket so that the retaining band is under tension and clamping the retaining band in place with clamps.

14. The method of claim 10, wherein the welding unit is a friction welder, the retaining band is formed of plastic and welding the first end and second end of retaining band to form a retaining hoop is conducted with friction welding.

15. The method of claim 11, wherein the retaining hoop is formed of flexible plastic and positioning the retaining hoop includes expanding the retaining hoop.

16. A method of forming and installing a retaining hoop on a roller supported in a support housing of a dough sheeting machine having a wire for scraping a surface of the roller, said method comprising:
positioning a retaining band around the roller and around the wire so that the wire is between the roller and the retaining band; and
welding first end of the retaining band to a second end of the retaining band to form a retaining hoop extending around the roller and around the wire.

17. The method of claim 16, wherein welding the first end of the retaining band to the second end of the retaining band includes positioning the first end and second end of the retaining band in a channel of an alignment bracket.

18. The method of claim 16, wherein welding the first end of the retaining band to the second end of the retaining band includes:
welding the first end and the second end of the retaining band with a friction weld formed by a welding unit mounted in the alignment bracket and moving the retaining hoop onto the roller to retain the wire against a cylindrical outer surface of the roller.

19. The method of claim 10, wherein the retaining hoop is formed of flexible plastic and positioning the retaining hoop includes expanding the retaining hoop around the roller.
